(19) United States
(12) Patent Application Publication
(10) Pub. No.: US 2015/0147728 A1
(43) Pub. Date: May 28, 2015

(54) Self Organizing Maps (SOMS) for Organizing, Categorizing, Browsing and/or Grading Large Collections of Assignments for Massive Online Education Systems

(71) Applicant: Kadenze, Inc., Valencia, CA (US)

(72) Inventors: Jordan N. Hochenbaum, Valencia, CA (US); Ajay Kapur, Valencia, CA (US); Owen S. Vallis, Valencia, CA (US); Perry R. Cook, Jacksonville, OR (US); Colin Honigman, Valencia, CA (US); Chad Wagner, Pasadena, CA (US)

(21) Appl. No.: 14/524,913

(22) Filed: Oct. 27, 2014

Related U.S. Application Data
(60) Provisional application No. 61/895,917, filed on Oct. 25, 2013.

(51) Int. Cl. G09B 19/00; G06F 17/30; G09B 5/06

(52) U.S. Cl. CPC G09B 19/0053; G09B 5/06; G06F 17/30598
USPC 434/118; 434/350; 707/738

(57) ABSTRACT

For courses that deal with media content, such as sound, music, photographic images, hand sketches, video, conventional techniques for automatically evaluating and grading assignments are generally ill-suited to direct evaluation of coursework submitted in media-rich form. Likewise, for courses whose subject includes programming, signal processing or other functionally-expressed designs that operate on, or are used to produce media content, conventional techniques are also ill-suited. Instead, it has been discovered that media-rich, indeed even expressive, content can be accommodated as, or as derivatives of, submissions using feature extraction and machine learning techniques. In this way, e.g., in on-line course offerings, even large numbers of students and student submissions may be accommodated in a scalable and uniform grading or scoring scheme. Likewise, large collections of coursework submissions (whether or not graded or scored) or media content more generally, may be efficiently browsed and grouped using techniques described herein.

### CROSS-REFERENCE TO RELATED APPLICATION(S)

The present application claims priority under 35 U.S.C. §119(e) or U.S. Provisional Application No. 61/895,917, filed Oct. 25, 2013.

### BACKGROUND

1. Field of the Invention

The present application is related to automated techniques for evaluating work product and, in particular, to techniques that employ feature extraction and machine learning to efficiently and consistently evaluate instances of media content that constitute, or are derived from, coursework submissions.

2. Description of the Related Art

As educational institutions seek to serve a broader range of students and student situations, on-line courses have become an increasingly important offering. Indeed, numerous instances of an increasingly popular genre of on-line courses, known as Massive Open Online Courses (MOOCs), are being created and offered by many universities, as diverse as Stanford, Princeton, Arizona State University, the Berkeley College of Music, and the California Institute for the Arts. These courses can attract tens of thousands of students each. In some cases, courses are offered free of charge. In some cases, new educational business models are being developed, including models in which students may be charged for deeper evaluation and/or credit, or in which advertising provides a revenue stream.

While some universities have created their own Learning Management Systems (LMS), a number of new companies have begun organizing and offering courses in partnership with universities or individuals. Examples of these include Coursera, Udacity, and edX. Still other companies, such as Moodle, Blackboard and Canvas, offer LMS designs and services for universities who wish to offer their own courses.

Students taking on-line courses usually watch video lectures, engage in blog/chat interactions, and submit assignments, exercises, and exams. Submissions may be evaluated (to lesser or greater degrees, depending on the type of course and nature of the material), and feedback on quality of coursework submissions can be provided. While many courses are offered that evaluate submitted assignments and exercises, the nature and mechanics of the evaluations are generally of three basic types:
1) In some cases, human graders evaluate the exercises, assignments, and exams. This approach is labor intensive, scales poorly, can have consistency/fairness problems and, as a general proposition, is only practical for smaller online courses, or courses where the students are (or someone is) paying enough to hire and train the necessary number of experts to do the grading.
2) In some cases, assignments and exams are crafted in multiple-choice, true false, or fill-in-the blank style, such that grading by machine can be easily accomplished. In some cases, the grading can be instant and interactive, helping students learn as they are evaluated, and possibly shortening the exam time, e.g., by guiding students to harder/easier questions based on responses. However, many types of subject matter, particularly those in which artistic expression or authorship are involved, do not lend themselves to such assignment or examination formats.
3) In some cases, researchers have developed techniques by which essay-style assignments and/or exams may be scanned looking for keywords, structure, etc. Unfortunately, solutions of this type are, in general, highly dependent on the subject matter, the manner in which the tests/assignment are crafted, and how responses are bounded.

Improved techniques are desired, particularly techniques that are scalable to efficiently and consistently serve large student communities and techniques that may be employed in subject matter areas, such as artistic expression, computer programming and even signal processing, that have not, to-date, proved to be particularly amenable to conventional machine grading techniques.

### SUMMARY

For courses that deal with media content, such as sound, music, photographic images, hand sketches, video (including videos of dance, acting, and other performances, computer animations, music videos, and artistic video productions), conventional techniques for automatically evaluating and grading assignments are generally ill-suited to direct evaluation of coursework submitted in media-rich form. Likewise, for courses whose subject includes programming, signal processing or other functionally-expressed designs that operate on, or are used to produce media content, conventional techniques are also ill-suited. Instead, it has been discovered that media-rich, indeed even expressive, content can be accommodated as, or as derivatives of, submissions using feature extraction and machine learning techniques. In this way, e.g., in on-line course offerings, even large numbers of students and student submissions may be accommodated in a scalable and uniform grading or scoring scheme. Likewise, large collections of coursework submissions (whether or not graded or scored) or media content more generally, may be efficiently browsed and grouped using techniques described herein.

Specifically, feature extraction and machine learning techniques may be employed to computationally process coursework submissions in a manner that presents a diverse and highly complex input set of coursework submissions to a human (e.g., an instructor or grader) in a manner that is more easily browsable. While the input space, even after feature extraction, is typically high-dimensional (in general, k-dimensional, k typically greater than 8), a mapped-to, human browsable reduced-dimension space derived using techniques in accordance with the present inventions may be of comparatively low (n) dimension, typically a 2- or 3-dimensional presentation/browsing space. Notwithstanding typical dimensionalities, as a general proposition, k simply exceeds n.

It has been discovered that, by using a computationally-reduced-dimension browsing space, instructors or graders, may efficiently browse a large set of coursework submissions, inspect exemplary submissions from various “neighborhoods” or regions of the reduced dimension space. Grades may be explicitly assigned to particular, inspected ones of the coursework submissions, while remaining submissions may be assigned grades by instructor established cut points in the reduced dimension space and/or by association with actually inspected ones of the submissions. In some cases, situations or embodiments, feature sets used to characterize the coursework submissions may be iteratively updated or extended by the instructor or grader, to improve discrimination between submissions that the instructor or grader views as of differing quality or caliber. In some cases, situations or embodiments, feature sets used to characterize the coursework submissions may be iteratively updated or extended by the instructor or grader, to improve clustering of submissions that the instructor or grader views as of like quality or caliber.

In some cases, situations or embodiments, the mapped-to, reduced-dimension space is computed as a self-organizing map (SOM) trained using exemplary works or submissions. Training sets may, in general, come from a current or prior administration of a course, and/or may include works of recognized masters in a particular field. Using the developed techniques, it is possible to administer courses and grade (in a computationally assisted manner) large volumes of submitted work that takes the form of media encodings of artistic expression, computer programming and even signal processing to be applied to media content. In some cases, situations or embodiments, the developed techniques may also, or alternatively, be used for plagiarism detection.

In some embodiments in accordance with the present invention(s), a method for use in connection with coursework submissions includes retrieving from storage, media content to be used in evaluating or organizing the coursework submissions, wherein at least some instances of the retrieved media content constitute, or are derived from, respective ones of the coursework submissions. For each instance of the media content, the method extracts a set of computationally defined features, wherein a set of values for the extracted computationally-defined features together constitute a k-dimensional feature vector that characterizes the corresponding instance of media content. The method initializes elements of an n-dimensional map, n less than k, with current feature vectors. Finally, the method assigns successive instances of the media content to respective elements of the map to which they most closely correspond and iteratively morphing the current feature vectors to produce a self-organized mapping wherein individual instances of the media content are distributed over the map and associated with respective elements thereof. In some illustrative cases, n=2 and k>8.

In some embodiments, the method further includes visually presenting a user with the map; and responsive to selection by the user of a given element thereof, presenting or rendering the associated media content. In some embodiments, the method further includes allowing the user to browse the media content using the map. In some cases, the user is an instructor or grader and the method further includes allowing an instructor or grader to define cut sets in the map; and assigning coursework submissions with grades or scores based on the instructor- or grader-defined cut sets.

In some embodiments, the assigning and iteratively morphing includes: (1) in successive computational cycles, (i) assigning respective instances of the media content and corresponding feature vectors to respective elements of the n-dimensional map, wherein a respective assigned-to element for a given instance of the media content is that for which the current feature vector most closely matches, based on a distance function, the feature vector that characterizes the given instance of media content, (ii) morphing the current feature vector for the assigned-to element toward the feature vector that characterizes the assigned given instance of media content and (iii) further morphing elements of the map spatially proximate the assigned-to element; and (2) further and iteratively morphing respective current feature vectors for elements of the map in accordance with decaying learning coefficients to produce self-organized n-dimensional mapping from k-dimensional feature vector space, wherein individual instances of the media content are associated with respective elements of the n-dimensional map. In some cases, the distance function calculates a Euclidian, Manhattan, Chebyshev and/or Minkowski distance between feature vectors.

In some embodiments, the method further includes identifying likely instances of plagiarism based on correspondence of feature vectors or mapped-to elements of the self-organized mapping. In some embodiments, the self-organized mapping is exclusive such that respective elements of the map are associated with only a single instance of the media content.

In some embodiments, at least some instances of the retrieved media content are, or are derived from, coursework submissions from a prior administration of a course. In some embodiments, the retrieved media content are, or are derived from, coursework submissions from a current administration of a course. In some embodiments, at least some instances of the retrieved media content are, or are derived from, exemplary works of recognized masters in a field of endeavor.

In some cases, the coursework submissions includes computer readable media encodings of expressive media content selected from the set of: captured musical or vocal performance; sketches, paintings, photographic images or other artistic still visuals; and synchronized audiovisual content, computer animation or other video that is itself expressive or visually captures underlying expression such as dance, acting, or other performance.

In some embodiments, the method further includes receiving from an instructor or grader a quality score for a selected instance of media content associated with an element of the map; and propagating the quality score to additional media content associated with neighboring elements of the map, wherein the additional media content constitutes, or is derived from, a respective one of the coursework submissions. In some cases, the propagating of the quality score to additional media content is in accordance with clusterings or gradients represented in the self-organized mapping. In some cases, the quality score is, or is a component of, a grading scale for an assignment- or test question-type coursework submission.

In some cases, the coursework submissions include software code submitted in satisfaction of a programming assignment or test question, the software code executable to perform, or compilable to execute and perform, digital signal processing to produce output media content; the media content includes exemplary output media content produced using exemplary software codes; and the particular quality score assigned to a particular coursework submission is based on the self-organized mapping of computationally defined features extracted from the output media content produced by execution of the submitted software code. In some cases, the software code coursework submission is executable to perform digital signal processing on input media content to produce the output media content; and the exemplary output media content is produced from the input media content using the exemplary software codes.

In some cases, the output media content includes images or video processed or rendered by the software code coursework submission. In some cases, the media content that constitutes, or is derived from, the coursework submission includes an audio signal encoding; and at least some of the computationally defined features are selected or derived from: a root mean square energy value; a number of zero crossings per frame; a spectral flux; a spectral centroid; a spectral roll-off measure; a spectral tilt; a mel-frequency cepstrum coefficients (MFCCs) representation of short-term power spectrum; a beat histogram; and/or a multi-pitch histogram computed over at least a portion of the audio signal encoding.

In some cases, the media content that constitutes, or is derived from, the coursework submission includes an image or video signal encoding; and at least some of the computationally defined features are selected or derived from: color histograms; two-dimensional transforms; edge, corner or ridge detections; curve or curvature features; a visual centroid; and/or optical flow computed over at least a portion of the image or video signal encoding.

In some cases, the extracted computationally-defined features include features computed over segments an audio, video or image encoded by the media content. In some cases, the segments are nested segments. In some cases, the k-dimensional feature vector used to characterize instances of the media content is reduced from a larger feature vector using a principal component analysis computed over the at least a subset of the media content. In some embodiments, the method further includes receiving from the instructor or curriculum designer at least an initial definition of the set of computationally defined features.

In some embodiments, a computational system includes one or more operative computers programmed to perform the method of any of the preceding methods. In some embodiments in accordance with the present invention(s), a computational system including one or more operative computers programmed to perform the method of any of foregoing methods. In some cases or embodiments, the computational system is itself embodied, at least in part, as a network deployed coursework submission system, whereby a large and scalable plurality (>50) of geographically dispersed students may individually submit their respective coursework submissions in the form of computer readable information encodings. In some cases or embodiments, the computational system includes a student authentication interface for associating a particular coursework submission with a particular one of the geographically dispersed students. In some embodiments in accordance with the present invention(s), non-transient computer readable encoding of instructions executable on one or more operative computers to perform any of the foregoing methods.

### BRIEF DESCRIPTION OF THE DRAWINGS

The present invention may be better understood, and its numerous objects, features, and advantages made apparent to those skilled in the art by referencing the accompanying drawings.

FIG. 1 depicts an illustrative networked information system in which students and instructors (and/or curriculum developers) interact with coursework management systems in accordance with some embodiments of the present invention(s).

FIGS. 2A, 2B and 2C depict a graphical user interface presentation of various stages of operation of a SOM-based classification system for music-type media content in accordance with some embodiments of the present invention(s).

FIGS. 3 and 4 depict respective instructor-side and student-side flows for a SOM-based classification system in accordance with some embodiments of the present invention(s).

FIG. 5 depicts both instructor-side and student-side portions of a feature extraction and machine learning system process flow for media-rich assignments or examinations in accordance with some embodiments of the present invention(s).

The use of the same reference symbols in different drawings indicates similar or identical items.

### DESCRIPTION OF THE PREFERRED EMBODIMENT(S)

The computational techniques described herein address practical challenges associated with administration of educational courses or testing, including on-line courses offered for credit to large and geographically dispersed collections of students (e.g., over the Internet), using advanced feature extraction techniques combined with machine learning (ML) algorithms. The developed techniques are also applicable to browsing of media content, such as that that may be prepared and/or presented in the context of on-line courses or exhibitions. The developed techniques are particularly well-suited to educational or testing domains in which assignments or test problems call for expressive content, such as sound, music, photographic images, hand sketches, video (including videos of dance, acting, and other performances, computer animations, music videos, and artistic video productions). The developed techniques are also well-suited to educational or testing domains in which assignments or test problems include programming, signal processing or other functionally expressed designs that operate on, or are used to produce media content, and which may be evaluated based on qualities of the resulting media content itself. In each of the foregoing cases, conventional techniques for automatically evaluating and grading assignments (typically multiple choice, true/false or simple fill-in-the-blank or short answer questions) are ill-suited to the direct evaluation of coursework that takes on media-rich forms.

Instead, it has been discovered that media-rich, indeed even artistic or expressive, content can be accommodated as, or as derivatives of, coursework submissions using feature extraction and machine learning techniques. In this way, e.g., in on-line course offerings, even large numbers of students and student submissions may be accommodated in a scalable and uniform grading or scoring scheme. Instructors or curriculum designers are provided with facilities to adaptively refine their assignments or testing based on classifier feedback. Using the developed techniques, it is possible to administer courses and automatically grade submitted work that takes the form of media encodings of artistic expression, computer programming and even signal processing to be applied to media content.

The developed techniques provide instructors/curriculum designers with systems and facilities to organize, cluster and summarize huge collections of submitted coursework. A family of machine learning-type techniques employed herein to classify coursework submissions is self-organizing maps (SOM) or self-organizing feature maps (SOFM). SOM, SOFM and like techniques or variations thereon (hereafter “SOM”) generally employ an artificial neural network (ANN) that is trained using unsupervised learning to produce a low-dimensional (typically two-dimensional), discretized representation of the input space of the training samples, called a map. Self-organizing maps differ from some other artificial neural networks in the sense that they use a neighborhood function to preserve the topological properties of the input space. This makes SOMs useful for visualizing low-dimensional views of high-dimensional data in a manner akin to multidimensional scaling. The SOM model was first described as an artificial neural network by the Finnish professor Teuvo Kohonen, and at least some implementations or variants are sometimes called Kohonen maps or networks.

Like most artificial neural networks, SOMs operate in two modes: training and mapping. “Training” builds the map using input examples (a competitive process, also called vector quantization), while “mapping” automatically classifies a new input vector. In some cases, situations or embodiments, a training data set may be substantially or essentially limited to current coursework submissions themselves. In some cases, situations or embodiments training data may include (or be “salted” with) hand-picked grading exemplars, works of recognized masters, and/or coursework submissions from prior administrations of a course. In each case, SOM techniques are used to classify elements of the data set (typically media content) based on computationally-defined features that are extracted from the elements. The resulting map, and specifically the underlying media content so classified, may then be browsed, inspected and performed (or rendered) in a manner that facilitates exploration of the data set and application of grades or scores to the coursework submissions that are, or correspond to, the underlying media content.

In some embodiments, a self-organizing map is implemented using computational elements or constructs that constitute or may be understood as nodes or artificial neural elements. Associated with each node is a weight vector of a same dimension as the input (or reduced) feature vectors and a position in the map space. A typical arrangement of nodes is a two-dimensional regular tessellation of elements of cells in a hexagonal or rectangular grid. The self-organizing map describes a mapping from a higher dimensional (k-dimensional) input space to a lower dimensional (here 2-dimensional, but generally, n-dimensional) map space. The procedure for placing a vector from data space onto the map is to find the node with the closest (smallest distance metric) weight vector to the data space vector.

### Illustrative System(s) for Automated Coursework Evaluation

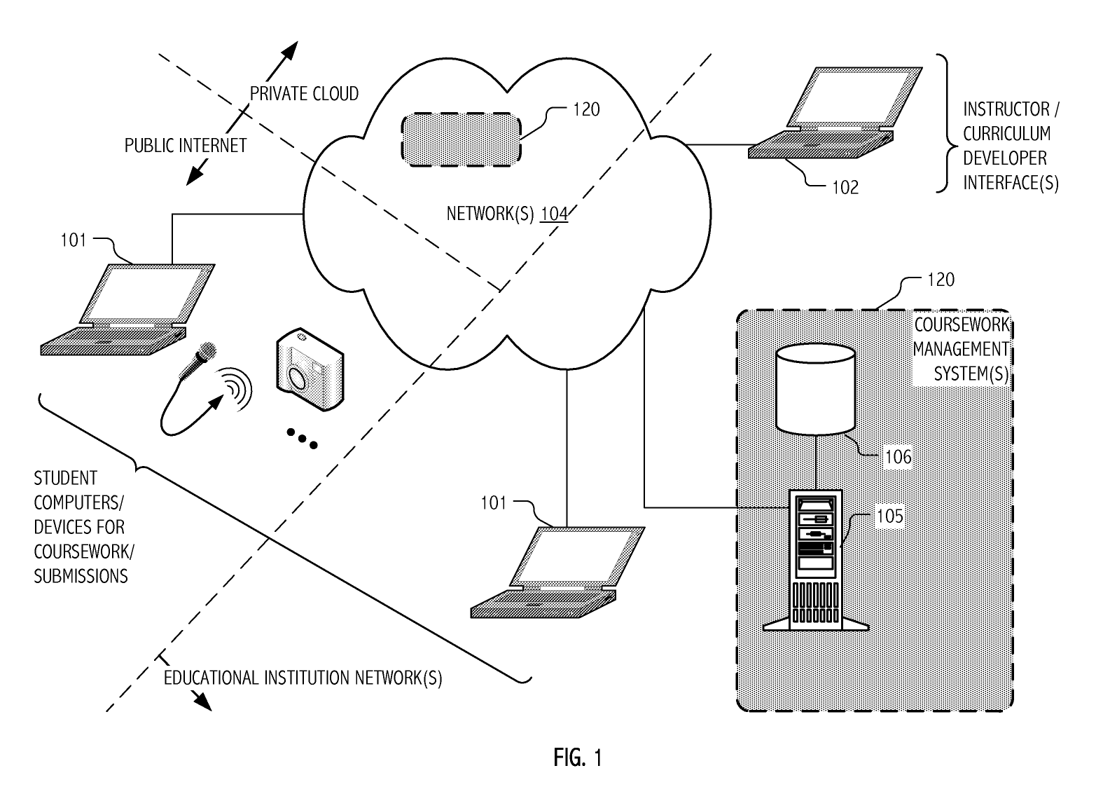

FIG. 1 depicts an illustrative networked information system in which students and instructors (and/or curriculum developers) interact with coursework management systems 120. In general, coursework management systems 120 such as described herein may be deployed (in whole or in part) as part of the information and media technology infrastructure (networks 104, servers 105, workstations 102, database systems 106, including e.g., audiovisual content creation, design and manipulation systems, code development environments, etc. hosted thereon) of an educational institution, testing service or provider, accreditation agency, etc. Coursework management systems 120 such as described herein may also be deployed (in whole or in part) in cloud-based or software-as-a-service (SaaS) form. Students interact with audiovisual content creation, design and manipulation systems, code development environments, etc. deployed (in whole or in part) on user workstations 101 and/or within the information and media technology infrastructure. In many cases, audiovisual performance and/or capture devices (e.g., cameras, microphones, 2D or 3D scanners, musical instruments, digitizers, etc.) may be coupled to or accessed by (or from) user workstations 101 in accordance with the subject matter of particular coursework and curricula.

### Coursework Evaluation Using SOMs

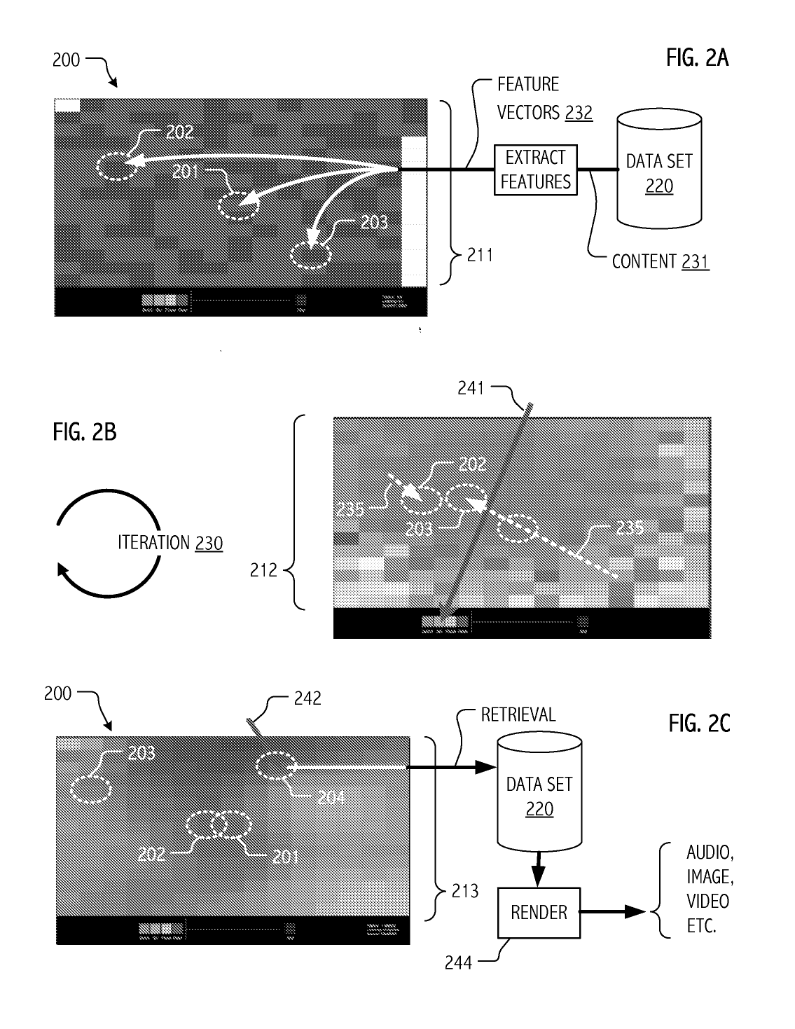

FIGS. 2A, 2B and 1C depict a graphical user interface presentation of various states or stages (211, 212, 213) of operation of a coursework management system (such as coursework management system 120, recall FIG. 1) SOM-based classification system for music-type media content. Specifically, FIG. 2A depicts initialization of the SOM, which in some cases, situations or embodiments may be initiated by selecting a particular coursework submission or media content 231 and associating it (and a feature vector 232 computed therefrom) with a position (e.g., 201) within the illustrated 2-dimensional map 200. Further coursework submissions or media content (e.g., 202, 203) from a data set 220 that includes the full set of coursework submissions may (together with computed feature vectors) be associated (in some cases randomly) with other positions (e.g., 202, 203 . . . ) in map 200. Optionally, further media content may include exemplars (e.g., from recognized masters or prior administrations of the course).

FIG. 2B depicts user initiated kick-off (241) of an iterative process 230 by which the SOM organizes the media content based on computationally-defined features 232 calculated from the media content instances. An algorithm description (below) presents an exemplary process. Likewise, suitable sets of computationally-defined features are detailed (below) for several exemplary media content types. However, in the context of FIG. 2B, persons of ordinary skill in the art will understand an iterative computational process by which placements of individual selections from data set 220 within 2D map 200 are updated (235) so as to iteratively converge on a final state (213, see FIG. 2C) in which distances between elements in a multi (k-dimensional) feature vector space are minimized. Stage or state 212 is illustrative of an interim state in this iterative computational process 230.

Finally, FIG. 2C depicts a resultant SOM state 213 in which media content examples are organized or classified by similarity (based on extracted feature vectors) and wherein smooth gradients provide a student, instructor or grader with a visual indicator of how similar (or different) various media content (e.g., 201, 202, 203 . . . 204 associated in FIG. 2C with illustrated positions in 2D map 200) so organized are to (or from) one another. Like colors (or grayscales) may be used indicate content that, at least insofar as the selected feature vectors are concerned, are closely related, while distant colors (or grayscales) indicate dissimilar media content. User selection (242) of a particular element (e.g., 204) operates to retrieve the corresponding coursework submission or media content for supply to an appropriate rendering engine (244) for audio, image, video or other content. In this way, an instructor, curriculum designer, student, etc. may explore and traverse the data set in a (reduced) 2D space that is organized and presented in a manner that corresponds to the larger dimensional (k-dimensional) feature space.

The resultant SOM state 213 is indicative of a trained-in mapping of feature vectors to positions in the map. This trained-in mapping may be employed in the classification of additional coursework submissions.

### SOM-Based Classification for Assignment Collections and Digital Media

### Algorithm Description

For each media file (i.e., each coursework submission or instance of media content), we analyze and compute “features”. We begin by dividing the media file into a number of smaller segments (e.g., regions of an image, or sections of a piece of music), and then analyze and extract the features for those segments. Each segment from a media file may also be segmented further as part of the process of deriving features for that segment. This nested segmentation then allows for one or more of the following statistics to be generated for each feature per media file:

1. Mean of the individual segment means

2. Standard Deviation of the individual segment means

3. Minimum of the individual segment means

4. Maximum of the individual segment means

5. Mean of the individual segment standard deviations

6. Standard Deviation of the individual segment standard deviations

7. Minimum of the individual segment standard deviations

8. Maximum of the individual segment standard deviations

These statistics are computed for a wide variety of standard computationally-defined features extractable for media instances in the database (e.g., in data set 220, recall FIGS. 2A, 2C). Once all the features are computed for all the relevant or desired media instances, they are then logged into a formatted text file in compliance with Weka's ARFF format—a popular format similar to CSVs used in the machine learning community.

At this point, the files are preprocessed using PCA (Principal Component Analysis) technique in order to reduce the number of features that contribute similar information about the media file, e.g., inches and cm would both give the same information regarding someone's height, so based on analysis they could be combined into a single feature. After this step, the features are normalized between 0 and 1. This not only evens out the impact of features that may have very large ranges, but also simplifies the mapping of feature vectors to color values in the SOM. Once this preprocessing is completed, normalized feature vectors are re-exported to ARFFs and loaded into the SOM application. Each media file from the database is tagged or linked to its corresponding feature vector (row) in the ARFF. The SOM then creates a two dimensional map, where each node/cell of the map contains a random vector (i.e. media example/instance) from the ARFF file. The SOM then randomly grabs one of the feature vectors from the ARFF, and then finds the node in the SOM that best matches this vector using a distance function such as Euclidian Distance. Note that in some situations or embodiments, it may be desirable to use or include other distance functions such as, e.g., Manhattan distance, Chebyshev distance and/or Minkowski distance. Once the best matching SOM node is found, the values in the node's vector are morphed towards the vector from the ARFF, taking into account a learning coefficient.

In this way, the SOM node comes closer to representing a media file from our database. Once this initial morphing is done, all nodes within a specified radius from the initial SOM node are also morphed; the amount of morphing decays as a function of the distance from the initial node. Both the learning rate and the radius are initial parameters defined by the user at the start of the SOM. These two parameters exponentially decay over a period of time, decreasing the amount of change that new ARFF vectors impart on the SOM map.

This process is iteratively repeated (recall iteration 230, FIG. 2B), defining the rate of decay for the learning and the radius. At the completion of the SOM training, the map will represent a topographical layout of feature vectors that are representative of, but not necessarily exactly the same as, the feature vectors in our ARFF. So to recap, the process takes a distance metric to find the best match between a random ARFF vector and the SOM map, updates the SOM nodes in the current neighborhood as a function of a learning rate and a radius parameter (which themselves are functions of the current iteration), and through iteratively running this process morphs a topographical map into a map that is representative of our actual data set.

At this point, the application finalizes associations between a single media file and its best matching node within the SOM—resulting in clusters of like media files. This can be thought of as clustering sub-genres of music, styles of painting, etc. The approach to mapping creates gradients between clusters/groups of such files.

### Example Mappings

As an example, a SOM implementation run on a collection of media content that includes recordings of early rock and roll and classic blues artists might expose a boundary along songs where the two genres overlap in musical styles or sounds. In at least some modes, situations or embodiments, the applied mapping technique is exclusive, i.e., a single media file is associated to a given map element. This exclusive-mapping technique contrasts with more traditional SOM mappings, in which the SOM may map files to nodes in a non-exclusive manner, creating a stacking approach. While this stacking approach enables hard-clusters (all best matches stack on top of each other, vs. spreading out across the map in a gradient of similarity), the exclusive-mapping technique has been found to present a browsing user with more interesting boundaries and edge relationships between the media files. This enables the SOM to act both as a classification tool, and also an exploration tool, when the subtle differences between media files displayed and navigated in on a gradient map.

Our SOM technique and application is also capable of presenting both human tagged color-coding, and color coding generated off of the raw feature data. This is useful to see ways in which the media may be similar, even when human labeling places them in separate artistic categories. Comparing these labels can give insight into new artistic genres, works, or media that students, teachers, or users may want to explore, but didn't know existed.

Lastly, the SOM can also be used to compare against exemplary homework files in order to gauge how well a student, or class is completing the assignments. Additionally, the SOM could be run over a large corpus of assignments to see how different assignments are between students. If the distance between two assignments is less than some threshold, it may be a flag for the professor to look for possible plagiarism issues. This is also the case if a student has tried to submit the same assignment for multiple homework assignments.

### Classification Frameworks, Operationally and More Generally

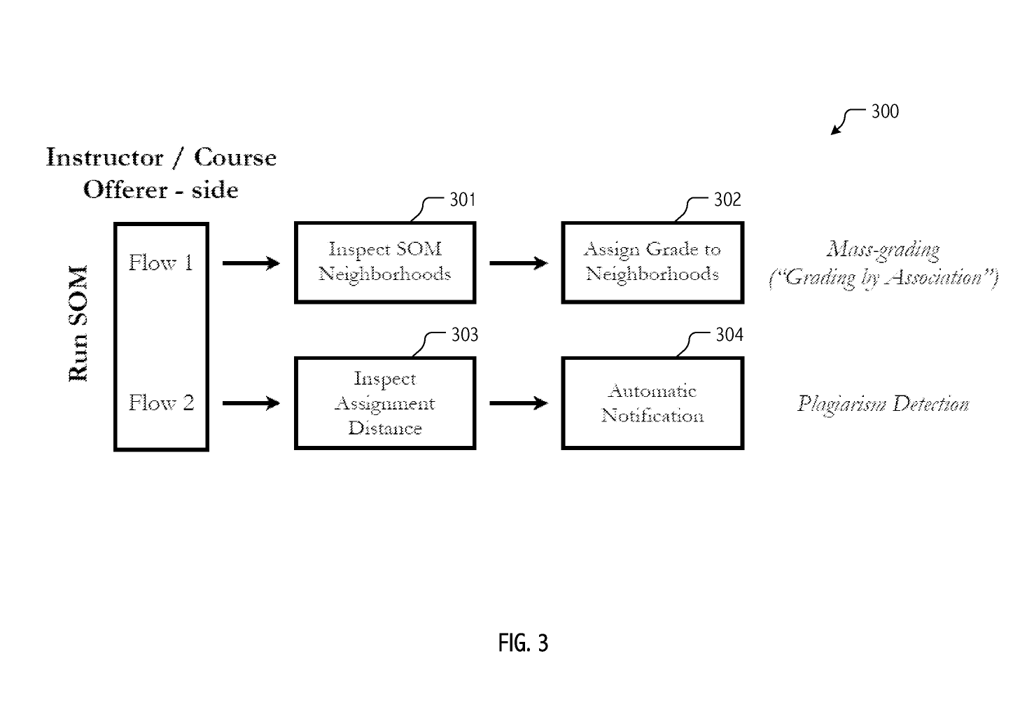

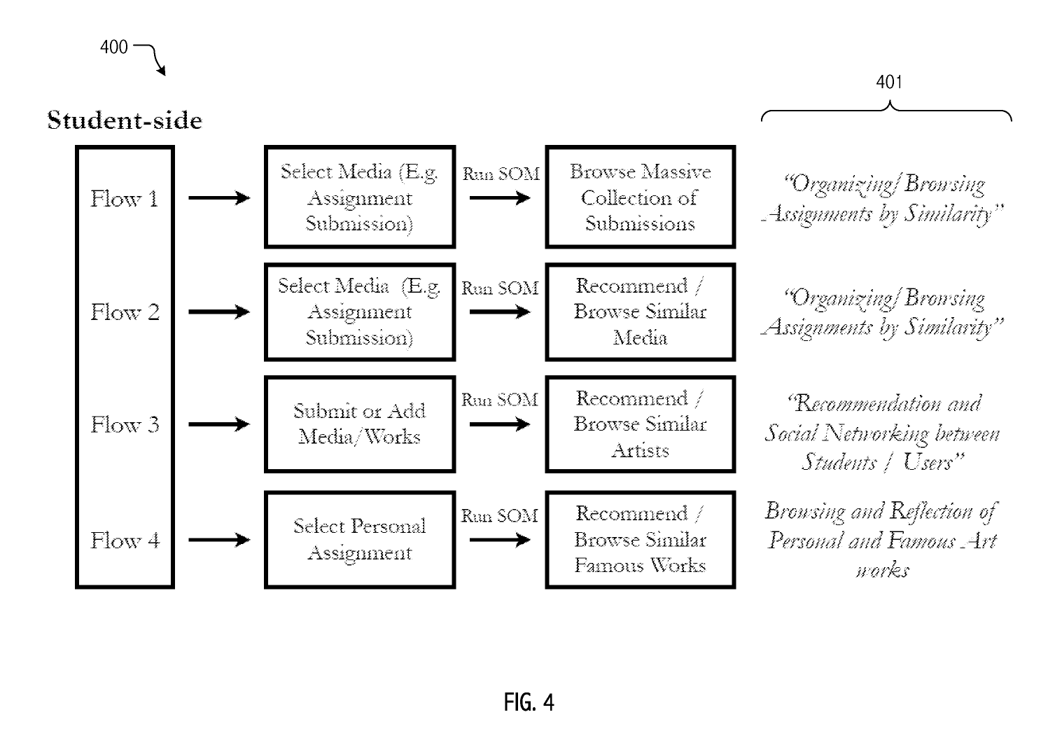

FIGS. 3 and 4 depict respective instructor-side (300) and student-side (400) flows in a SOM-based classification system in accordance with some embodiments of the present invention(s). Specifically, and for a course offering, the SOM-based classification techniques described herein may be used to classify large volumes of coursework submissions, allow the instructor or grader to inspect (301) selected SOM neighborhoods within classified content and facilitate assignment (302) of grades by neighborhood and propagation to the full set of coursework submissions by association in accordance with gradients encoded in the SOM. Additionally, in some cases, situations or embodiments, coursework submissions may be identified based on similarity of extracted features (303) and an instructor or grader automatically notified (304) of possible plagiarism. Plagiarism detection may be especially effective where coursework submissions from prior administrations of the course are included in the data set over which the SOM is computed. On the student-side, and as illustrated in FIG. 4, a variety of browsing and/or content recommendation features (401) may be provided based on the SOM-based classification of media content.

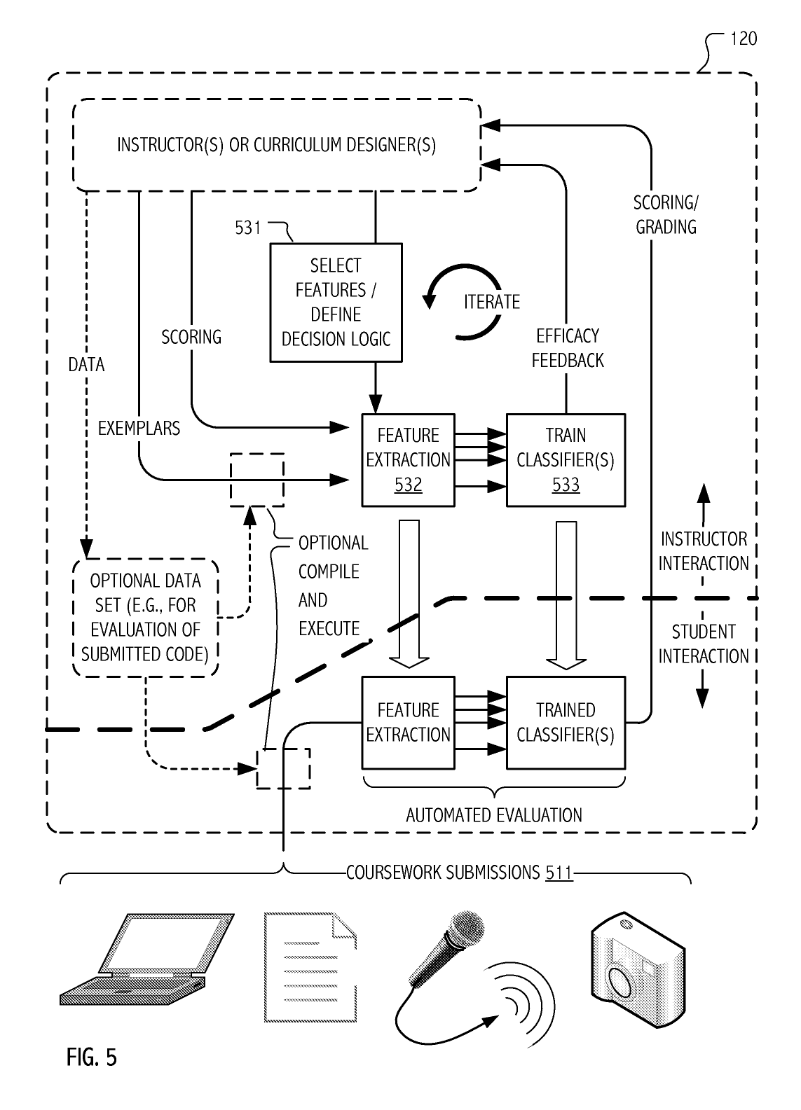

Although embodiments of the present invention are explained in the context of certain illustrative SOM-based techniques, certain operational aspects may be more generally understood simply in the context of media content classification. FIG. 5 illustrates certain exemplary classification and grading flows of a coursework management system (e.g., coursework management system 120, recall FIG. 1) in which, based on the description herein, it will be understood that classifiers may implement SOM-based techniques.

The system extracts (532) computationally-defined features from the training examples, and these extracted features are used to train (533) a computational system that implements a SOM-based classifier. Training of the SOM-based classifier to map individual coursework submissions to positions in the map (recall map 200, FIGS. 2A, 2B and 2C) can be accomplished in the manner described herein.

In general, as part of a potentially iterative coursework evaluation design process, an operative set of feature extractors may be interactively selected or defined (531) for a particular assignment or test question, and refined based on efficacy. In some cases, SOM-based systems or methods in accordance with the present inventions may be augmented to provide (and/or guide) the instructor or curriculum designer through a menu or hierarchy of feature extractor selections and/or classification stages. In some cases, it may be desirable to allow the instructor/curriculum designer to identify (or label) what is good or bad about the training examples. For example, in an application of the developed techniques to grading of music coursework submissions, systems and methods may allow the instructor/curriculum designer to note that a training example (or even a particular coursework submission inspected) is (1) in the key of C, (2) has more than 2, but less than 10, discernible sections, (3) has a very strong beat, etc.

The classifier learns to categorize submissions in accordance with SOM-based mapping, with or without augmentation based on the instructor or curriculum designer's classifications (e.g., on a grading scale or against a rubric), and (at least during training) provides the instructor or curriculum designer with feedback as to how well submissions will be able to be classified based on the current training. In some cases, the system can make suggestions as to how to change the task or criteria so that submissions are easier to classify and thus grade. In response, the instructor or curriculum designer can modify the assignment or evaluation criteria, resubmitting the original examples or modified ones, until they (and the system) are satisfied that the system will perform well enough for grading student submissions.

“Good” examples (i) can come from historical or current masters in the field or can be examples that are representative of the style being emulated, (ii) can be generated by the curriculum designer or (iii) can include previous student submissions from prior administrations of the course (or even hand-picked grading exemplars from a current administration of the course). In some cases or educational domains, initial bad examples can be provided by the curriculum designer or drawn from student submissions (whether from prior administrations or current exemplars). In some cases, once the system is used to offer a course or evaluate an assignment once, prior training serves as a baseline and hand-selected student submissions are thereafter used to re-train the system, or refine the training, for better results.

Aside from speed and convenience, and the ability to evaluate thousands rather than tens of submissions in a short time can provide significant advantages. Furthermore, in some cases or embodiments, computational capabilities of the classifier may be scaled as needed, e.g., by purchasing additional compute power, such as via cloud services or compute farms. Additional benefits include absolute objectivity and fairness. All assignments can be evaluated by exactly the same rules and trained machine settings. This is not the case with a collection of human examiners, who inevitably bring biases and grow fatigued during/between sessions, yielding inconsistent results.

Typically, once the SOM is trained, additional coursework submissions 511 are presented for automated evaluation as computer readable media encodings uploaded or directly selected by students from their respective workspaces. In some cases, a course administrator may act as an intermediary and present the coursework submissions 511 to an automated coursework evaluation system. Suitable encoding formats are dependent on the particular media content domain to which techniques of the present invention are applied and are, in general, matters of design choice. Nonetheless, persons of skill in the art, having benefit of the present disclosure will appreciate use of suitable data access methods and/or codecs to obtain and present media content in data structural forms that are, in turn, suitable or convenient for feature extraction and use as classifier inputs in any particular implementation of the techniques described herein.

### Additional Considerations

As online courses become more popular and are offered for credit, a further concern arises related to verification and authentication of the student taking the course and submitting assignments. Cases of fraud, e.g., where someone is hired to do the work for someone else who will receive credit, must be avoided if possible. Some institutions who offer online for credit require physical attendance at proctored examinations. As online courses expand to offer credit in geographically diverse locations, and as class sizes grow, supervised exams can become impractical or impossible. The techniques implemented by systems described herein can help with this problem, using the same or similar underlying frameworks for voice, face, and gesture recognition. If required, the user can be required to authenticate themself, e.g., via WebCam, with each assignment submission, or a number of times throughout an online exam. In some cases or embodiments, a student authentication may use the same or similar features used to grade assignments to help determine or confirm identity of the coursework submitter For example, in some cases or embodiments, computationally-defined features extracted from audio and/or video provided in response to a “Say your name into the microphone” direction or a “Turn on your webcam, place your face in the box, and say your name” requirement may be sufficient to reliably establish (or confirm) identity of an individual taking a final exam based, at least in part, on data from earlier coursework submissions or enrollment.

### Media-Rich Grading Examples:

### Music Programming:

One illustrative example of a media-rich educational domain in which techniques of the present invention may be employed is music programming, i.e., digital signal processing as applied to audio encodings of music. In a music programming course, students may be given an assignment to develop a computer program to perform some desired form of audio processing on an audio signal encoding. For example, a student might be assigned the task of developing programming to reduce the dynamic range of an existing audio track (called compression), by computing a running average of the RMS power in the signal, then applying a dynamically varying gain to the signal in order to make louder segments softer, and softer segments louder, thus limiting the total dynamic range.

In support of such an assignment, the systems and methods described herein may perform an initial textual and structural evaluation of the students' submitted coursework (here, computer code). Using lexical and/or syntactic analysis, it is possible to determine conformance with various elements required by the assignment, e.g., use of calling structures and required interfaces, use of particular computational primitives or techniques per the assignment, coding within storage use constraints, etc. Next, the systems and methods may compile the submitted code automatically (e.g., to see if it compiles; if not, the student must re-submit). Once compiled, the coursework submission may be executed against a data set to process audio input and/or generate audio output. Alternatively or in addition, the student's submission itself may include results (e.g., an encoded audio signal) generated by execution of the coursework submission against a data set to process audio input and/or generate audio output. In either case, the audio features are extracted from the audio signal output and supplied to the classifiers of the machine-grading system to produce a grading or score for the coursework submission.

FIG. 5 depicts both instructor-side and student-side portions of a feature extraction and machine learning system process flow for media-rich assignments or examinations in accordance with some embodiments of the present invention(s). In a simple use case, the instructor or curriculum provides a first set of exemplars that she scores, classifies or labels as “good” and provides first set of exemplars that she scores, classifies or labels as “bad.” The instructor or curriculum, then trains the illustrated computational machine by selecting/paring features or expressing rules or other decision logic, as needed, to computationally classify the exemplars (and subsequent coursework submissions) in accord with the desired classifications. As will be appreciated by persons of ordinary skill in the art having benefit of the present disclosure, scores, classes or labels of interest may be multi-level, multi-variate, and/or include less crass or facially apparent categorizations. For example, classifiers may be trained to classify in accordance with instructor or curriculum provided scores (e.g., ratings from 0 to 6 on each of several factors or, in some cases, composite letter grades) or labels (e.g., male/female, expert/intermediate/amateur, or student name/ID), etc.

### Audio Features:

Although the selection of particular audio features to extracted may be, in general, assignment- or implementation-dependent (and in some cases or embodiments may be augmented or extended with instructor- or curriculum-defined feature extraction modules), an exemplary set of audio feature extraction modules may be provided for selection by the instructor or curriculum designer. For example, in some cases or embodiments, the following computationally-defined feature extractions may be provided or selected with computations over windows of various size (20, 50, 100 ms, 0.5 s, 1 s typical):
RMS (Root Mean Square) energy of the audio signal;
Number of zero crossings (per frame) in the audio signal;
Spectral flux (frame to frame difference of power spectra, e.g., FFT magnitude) of the audio signal;
Spectral centroid (center of gravity of power spectrum, brightness measure) of the audio signal;
Spectral roll-off frequency for the audio signal (below this freq., X % of total power spectrum energy lies);
Spectral tilt of the audio signal (slope of line fit to power spectrum or log power spectrum);
mel-frequency cepstrum coefficients (MFCCs) representation of short-term power spectrum for the audio signal (inverse transform of log of power spectrum, warped to Mel freq. scale);
Beat histogram for the audio signal (non-linear autocorrelation-based estimates of music/sonic pulse); and/or
Multi-pitch histograms for the audio signal (extract sinusoids, cluster by harmonicity, calculate pitches).

In general, means and standard deviations of these and/or or other extracted features are computed (often over different windows) and used to characterize sound and music. In some cases, signals may be segmented, and features computationally extracted over contextually-specific segments. Using various metrics, distance functions, and systems, including artificial neural network (NN), k-nearest neighbor (KNN), Gaussian mixture model (GMM), support vector machine (SVN) and/or other statistical classification techniques, sounds/songs/segments can be compared to others from a previously scored or graded database of training examples. By classifying coursework submissions against a computational representation of the scored or graded training examples, individual coursework submissions are assigned a grade or score. In some case or embodiments, features (or feature sets) can be compressed to yield “fingerprints,” making search/comparison faster and more efficient. Based on the description herein, persons of ordinary skill in the art will appreciate both a wide variety of computationally-defined features that may be extracted from the audio signal of, or that derived from, a coursework submission and a wide variety of computational techniques for classifying such coursework submissions based on the extracted features.

### Art and Video:

Although music programming and extracted audio features are used as an initial descriptive context for certain exemplary embodiments in accord with the present invention(s), persons of ordinary skill in the art will (based on the present disclosure) also appreciate applications to other media-rich, indeed even expressive, content. For example, turning illustratively to images and/or video, it will be appreciated that it is possible to compute features from still images, or from a succession of images (video) using similar or at least analogous techniques applied generally as described above. Techniques in this sub-domain of signal processing are commonly referred to as “computer vision” and, as will be appreciated by persons of ordinary skill in these arts having benefit of the present disclosure, analogous features for extraction can include color histograms, 2D Transforms, edges/corners/ridges, curves and curvature, blobs, centroids, optical-flow, etc.

As before, means and standard deviations of these and/or or other extracted features are computed (often over different windows) and used to characterize the images or video. Again, extracted feature sets may be used to classify coursework submissions against a graded or scored set of exemplars.

### Other Embodiments and Variations

While the invention(s) is (are) described with reference to various embodiments, it will be understood that these embodiments are illustrative and that the scope of the invention(s) is not limited to them. Many variations, modifications, additions, and improvements are possible. For example, while certain illustrative signal processing and machine learning techniques have been described in the context of certain illustrative media-rich coursework and curricula, persons of ordinary skill in the art having benefit of the present disclosure will recognize that it is straightforward to modify the described techniques to accommodate other signal processing and machine learning techniques, other forms of media-rich coursework and/or other curricula. Likewise, while techniques have been described in the illustrative context of self-organizing maps (SOMs), persons of skill in the art having benefit of the present disclosure will appreciate applicability of the techniques described (and claimed) to related machine learning techniques, such as, for example, generative topographic maps (GTMs) which can be understood as a probabilistic counterpart of the SOM.

Both instructor-side and student-side portions of a feature extraction and machine learning system process flows for media-rich coursework have been described herein in accordance with some embodiments of the present invention(s). In simplified, yet illustrative use cases, the instructor or curriculum designer may provide the SOM with a set of exemplars that she scores or labels as “good” and provides set of exemplars that she scores or labels as “bad.” The instructor or curriculum, then may train the illustrated computational machine by selecting/pairing features or expressing rules or other decision logic, as needed, to computationally classify the exemplars (and subsequent coursework submissions) in accord with the desired scorings or labels. As will be appreciated by persons of ordinary skill in the art having benefit of the present disclosure, scores, classes or labels of interest may be multi-level, multi-variate, and/or include multiple tiers and/or more complex categorizations. For example, classifiers may be trained to classify in accordance with instructor or curriculum provided scores (e.g., ratings from 0 to 6 on each of several factors, on a 100-point scale or, in some cases, as composite letter grades) or labels (e.g., expert/intermediate/amateur), etc.

Likewise, while audio processing, music programming and extracted audio features are used as an descriptive context for certain exemplary embodiments in accord with the present invention(s), persons of ordinary skill in the art will (based on the present disclosure) also appreciate applications to other media-rich, indeed even expressive, content. For example, turning illustratively to visual art, images and/or video, it will be appreciated that it is possible to compute features from still images, or from a succession of images (video) using similar or at least analogous techniques applied generally as described above. Techniques in this sub-domain of signal processing are commonly referred to as “computer vision” and, as will be appreciated by persons of ordinary skill in these arts having benefit of the present disclosure, analogous features for extraction can include color histograms, 2D Transforms, edges/corners/ridges, curves and curvature, blobs, centroids, optical-flow, etc. In video targeted applications, detection of sections and transitions (fades, cuts, dissolves, etc.) may be used in automated grading, particularly where a rubric asks students to use at least one each of jump-cut, fade, cross-dissolve, or to have at least three separate “scenes”. As with the audio processing examples above, decision tree logic and computationally-defined features may be employed to detect sections and transitions (here, fades, cuts, dissolves, etc.) between sections. If statistics for sections differ, grading/scoring can be based on the presence, character or structure of the sections or transitions and correspondence with a rubric. Means and standard deviations of these and/or or other extracted features are computed (often over different windows) and used to characterize the images or video. Again, extracted feature sets may be used to classify coursework submissions against a graded or scored set of exemplars.

Using various metrics, distance functions, and systems including SOM-based artificial neural network (NN) systems described herein, k-nearest neighbor (KNN), Gaussian mixture model (GNN), support vector machine (SVN) and/or other statistical classification techniques, images/video segments can be compared to others from a previously scored or graded database of training examples. While illustrative techniques based on a particular distance functions, learning coefficients and spatial/temporal decay have been described, it will be appreciated that any of a variety of distance functions, learning functions and decays may be employed. By classifying coursework submissions against a computational (SOM) representation of the scored or graded training examples, coursework submissions are grouped and individual and representative submissions may be assigned a grade or score that may be consistently propagated to neighboring submissions and throughout the map media content based on the information encoded in the SOM itself.

Embodiments in accordance with the present invention(s) may take the form of, and/or be provided as, a computer program product encoded in a machine-readable medium as instruction sequences and other functional constructs of software, which may in turn be executed in a computational system to perform methods described herein. In general, a machine readable medium can include tangible articles that encode information in a form (e.g., as applications, source or object code, functionally descriptive information, etc.) readable by a machine (e.g., a computer, server, virtualized compute platform or computational facilities of a mobile device or portable computing device, etc.) as well as non-transitory storage incident to transmission of the information. A machine-readable medium may include, but is not limited to, magnetic storage medium (e.g., disks and/or tape storage); optical storage medium (e.g., CD-ROM, DVD, etc.); magneto-optical storage medium; read only memory (ROM); random access memory (RAM); erasable programmable memory (e.g., EPROM and EEPROM); flash memory; or other types of medium suitable for storing electronic instructions, operation sequences, functionally descriptive information encodings, etc.

In general, plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the invention(s).

What is claimed is:

1. A method for use in connection with coursework submissions, the method comprising:
retrieving from storage, media content to be used in evaluating or organizing the coursework submissions, wherein at least some instances of the retrieved media content constitute, or are derived from, respective ones of the coursework submissions;
for each instance of the media content, extracting a set of computationally defined features, wherein a set of values for the extracted computationally-defined features together constitute a k-dimensional feature vector that characterizes the corresponding instance of media content;
initializing elements of an n-dimensional map, n less than k, with current feature vectors; and
assigning successive instances of the media content to respective elements of the map to which they most closely correspond and iteratively morphing the current feature vectors to produce a self-organized mapping wherein individual instances of the media content are distributed over the map and associated with respective elements thereof.

2. A method as in claim 1,
wherein n=2 and k>8.

3. A method as in claim 1, further comprising:
visually presenting a user with the map; and
responsive to selection by the user of a given element thereof, presenting or rendering the associated media content.

4. A method as in claim 3, further comprising:
allowing the user to browse the media content using the map.

5. A method as in claim 3, wherein the user is an instructor or grader and further comprising:
allowing an instructor or grader to define cut sets in the map; and
assigning coursework submissions with grades or scores based on the instructor- or grader-defined cut sets.

6. A method as in claim 1, wherein the assigning and iteratively morphing includes:
in successive computational cycles, (i) assigning respective instances of the media content and corresponding feature vectors to respective elements of the n-dimensional map, wherein a respective assigned-to element for a given instance of the media content is that for which the current feature vector most closely matches, based on a distance function, the feature vector that characterizes the given instance of media content, (ii) morphing the current feature vector for the assigned-to element toward the feature vector that characterizes the assigned given instance of media content and (iii) further morphing elements of the map spatially proximate the assigned-to element; and
further and iteratively morphing respective current feature vectors for elements of the map in accordance with decaying learning coefficients to produce self-organized n-dimensional mapping from k-dimensional feature vector space, wherein individual instances of the media content are associated with respective elements of the n-dimensional map.

7. A method as in claim 6,
wherein the distance function calculates a Euclidian, Manhattan, Chebyshev and/or Minkowski distance between feature vectors.

8. A method as in claim 1, further comprising:
identifying likely instances of plagiarism based on correspondence of feature vectors or mapped-to elements of the self-organized mapping.

9. A method as in claim 1,
wherein the self-organized mapping is exclusive such that respective elements of the map are associated with only a single instance of the media content.

10. A method as in claim 1,
wherein at least some instances of the retrieved media content are, or are derived from, coursework submissions from a prior administration of a course.

11. A method as in claim 1,
wherein the retrieved media content are, or are derived from, coursework submissions from a current administration of a course.

12. A method as in claim 1,
wherein at least some instances of the retrieved media content are, or are derived from, exemplary works of recognized masters in a field of endeavor.

13. A method as in claim 1, wherein the coursework submissions includes computer readable media encodings of expressive media content selected from the set of:
captured musical or vocal performance;
sketches, paintings, photographic images or other artistic still visuals; and
synchronized audiovisual content, computer animation or other video that is itself expressive or visually captures underlying expression such as dance, acting, or other performance.

14. A method as in claim 1, further comprising:
receiving from an instructor or grader a quality score for a selected instance of media content associated with an element of the map; and
propagating the quality score to additional media content associated with neighboring elements of the map, wherein the additional media content constitutes, or is derived from, a respective one of the coursework submissions.

15. A method as in claim 14,
wherein the propagating of the quality score to additional media content is in accordance with clusterings or gradients represented in the self-organized mapping.

16. A method as in claim 15,
wherein the quality score is, or is a component of, a grading scale for an assignment- or test question-type coursework submission.

17. A method as in claim 15,
wherein the coursework submissions include software code submitted in satisfaction of a programming assignment or test question, the software code executable to perform, or compilable to execute and perform, digital signal processing to produce output media content;
wherein the media content includes exemplary output media content produced using exemplary software codes; and
wherein the particular quality score assigned to a particular coursework submission is based on the self-organized mapping of computationally defined features extracted from the output media content produced by execution of the submitted software code.

18. A method as in claim 17,
wherein the software code coursework submission is executable to perform digital signal processing on input media content to produce the output media content; and
wherein the exemplary output media content is produced from the input media content using the exemplary software codes.

19. A method as in claim 17,
wherein the output media content includes images or video processed or rendered by the software code coursework submission.

20. A method as in claim 1,
wherein the media content that constitutes, or is derived from, the coursework submission includes an audio signal encoding; and
wherein at least some of the computationally defined features are selected or derived from:
a root mean square energy value;
a number of zero crossings per frame;
a spectral flux;
a spectral centroid;
a spectral roll-off measure;
a spectral tilt;
a mel-frequency cepstrum coefficient (MFCC) representation of short-term power spectrum;
a beat histogram; and/or
a multi-pitch histogram
computed over at least a portion of the audio signal encoding.

21. A method as in claim 1,
wherein the media content that constitutes, or is derived from, the coursework submission includes an image or video signal encoding; and
wherein at least some of the computationally defined features are selected or derived from:
color histograms;
two-dimensional transforms;
edge, corner or ridge detections;
curve or curvature features;
a visual centroid; and/or
optical flow
computed over at least a portion of the image or video signal encoding.

22. A method as in claim 1,
wherein the extracted computationally-defined features include features computed over segments an audio, video or image encoded by the media content.

23. A method as in claim 22, wherein the segments are nested segments.

24. A method as in claim 1,
wherein the k-dimensional feature vector used to characterize instances of the media content is reduced from a larger feature vector using a principal component analysis computed over the at least a subset of the media content.

25. A method as in claim 1, further comprising:
receiving from the instructor or curriculum designer at least an initial definition of the set of computationally defined features.

26. A computational system including one or more operative computers programmed to perform the method of claim 1.

27. The computational system of claim 26 embodied, at least in part, as a network deployed coursework submission system, whereby a large and scalable plurality (>50) of geographically dispersed students may individually submit their respective coursework submissions in the form of computer readable information encodings.

28. The computational system of claim 27 including a student authentication interface for associating a particular coursework submission with a particular one of the geographically dispersed students.

29. A non-transient computer readable encoding of instructions executable on one or more operative computers to perform the method of claim 1.
